(19) United States
(12) Patent Application Publication
(10) Pub. No.: US 2022/0062702 A1
(43) Pub. Date: Mar. 3, 2022

(54) INFORMATION PROCESSING APPARATUS AND INFORMATION PROCESSING METHOD

(71) Applicant: SONY GROUP CORPORATION, TOKYO (JP)

(72) Inventor: HIDEYUKI MATSUNAGA, TOKYO (JP)

(21) Appl. No.: 17/309,906

(22) PCT Filed: Jan. 11, 2019
(86) PCT No.: PCT/JP2019/000609

§ 371 Date: Jun. 28, 2021

(51) Int. Cl. A63B 24/00; G06K 9/00

(52) U.S. Cl. CPC A63B 24/0006; A63B 2024/0015; A63B 24/0075; G06K 9/00369

(57) ABSTRACT

[Object] More efficient evaluation of the motions of multiple users is made possible. [Solving Means] An information processing apparatus is provided that includes a motion estimation section configured to analyze data recorded of motions of multiple users so as to estimate the motions, a tag addition section configured to add tag data regarding the motions to at least part of the recorded data, and a motion evaluation section configured to evaluate the motions by comparing the motions with reference motions on the basis of the tag data.

### TECHNICAL FIELD

The present disclosure relates to an information processing apparatus and an information processing method.

### BACKGROUND ART

In recent years, technologies have been developed that permit evaluation of the motion of a user by use of various sensors. For example, PTL 1 cited below discloses a technology that evaluates a motion of a user by generating image data through imaging of the user's motion using a camera and by analyzing the generated image data.

### CITATION LIST

### Patent Literature

[PTL 1]

Japanese Patent Laid-Open No. 2011-84375

### SUMMARY

### Technical Problem

However, according to the technology described in PTL 1 and other technologies, the motions of multiple users cannot be evaluated efficiently. For example, the technology described in PTL 1 cannot analyze the image data (incidentally, not just the image data but other data as well) acquired of multiple users so as to evaluate the motion of each user.

The present disclosure has been made in view of the above circumstances and aims to provide a novel and improved information processing apparatus and information processing method for evaluating the motions of multiple users more efficiently.

### Solution to Problem

According to the present disclosure, there is provided an information processing apparatus including a motion estimation section configured to analyze data recorded of motions of multiple users so as to estimate the motions, a tag addition section configured to add tag data regarding the motions to at least part of the recorded data, and a motion evaluation section configured to evaluate the motions by comparing the motions with reference motions on the basis of the tag data.

Also, according to the present disclosure, there is provided an information processing method to be executed by a computer, the information processing method including analyzing data recorded of motions of multiple users so as to estimate the motions, adding tag data regarding the motions to at least part of the recorded data, and evaluating the motions by comparing the motions with reference motions on the basis of the tag data.

### BRIEF DESCRIPTION OF DRAWINGS

FIG. 1 is a block diagram depicting a configuration example of an information processing system according to an embodiment of the disclosure.

FIG. 2 is a block diagram depicting a configuration example of an information processing apparatus according to the present embodiment.

FIG. 3 is a diagram for explaining a data extraction process performed by a data extraction section according to the present embodiment.

FIG. 4 depicts diagrams for explaining a posture estimation process performed by a posture estimation section according to the present embodiment.

FIG. 5 is a diagram for explaining a process of reconstitution in a three-dimensional coordinate system performed by a reconstitution section according to the present embodiment.

FIG. 6 is a diagram depicting specific examples of tag data according to the present embodiment.

FIG. 7 depicts diagrams for explaining a motion evaluation process performed by a motion evaluation section according to the present embodiment.

FIG. 8 depicts other diagrams for explaining the motion evaluation process performed by the motion evaluation section according to the present embodiment.

FIG. 9 is a diagram depicting a specific example of image data displayed on an output apparatus under control of an output control section according to the present embodiment.

FIG. 10 is a flowchart depicting a typical process flow ranging from acquisition of sensor data to output of a result of motion evaluation according to the present embodiment.

FIG. 11 is a flowchart depicting a typical process flow regarding the output of motion evaluation results according to the present embodiment.

FIG. 12 is a diagram depicting specific examples of first image data and second image data displayed on the output apparatus according to the present embodiment.

FIG. 13 is a diagram depicting specific examples of the first image data and the second image data displayed overlaid on the output apparatus according to the present embodiment.

FIG. 14 is a diagram depicting specific examples of two or more items of the second image data displayed in an overlaid manner with respect to the first image data on the output apparatus according to the present embodiment.

FIG. 15 is a diagram depicting a specific example of how the output apparatus according to the present embodiment displays part or all of image data as the first image data, and part or all of the image data acquired of a reference motion beforehand as the second image data.

FIG. 16 is a diagram depicting a specific example of image data displayed on the output apparatus according to the present embodiment in order to verify the results of evaluating the motions of multiple users over a given time period.

FIG. 17 is a diagram depicting a specific example of image data displayed on the output apparatus according to the present embodiment in order to verify the results of evaluating the motion of a user over a given time period.

FIG. 18 is a diagram depicting a specific example of tag data according to a modification example.

FIG. 19 is a flowchart depicting more specifically the process of step S1028 in FIG. 10 (estimation of motions and addition of tag data) according to the modification example.

FIG. 20 is a flowchart depicting more specifically the process of step S1036 in FIG. 10 (evaluation of motions and addition of tag data) according to the modification example.

FIG. 21 is a block diagram depicting a hardware configuration example of the information processing apparatus according to the present embodiment or the modification example.

### DESCRIPTION OF EMBODIMENTS

Some preferred embodiments of the present disclosure are described below in detail with reference to the accompanying drawings. Incidentally, throughout the ensuing description and the drawings, the constituent elements having substantially identical functions and configurations are represented by the same reference characters, and the redundant explanations are not repeated.

Incidentally, the description is made in the following order.

1. Overview

2. Configuration examples

3. Process flow examples

4. Display examples

5. Modification example

6. Hardware configuration example

7. Conclusion

### 1. OVERVIEW

An overview of the present disclosure is explained first.

In recent years, technologies such as that described in the above-cited PTL 1 have been developed that can evaluate the motion of a user by use of various sensors. However, these technologies including that of PTL 1 have failed to evaluate the motions of multiple users efficiently.

For example, the technology described in PTL 1 cannot analyze the image data acquired of multiple users so as to evaluate the motion of each user. More specifically, although the technology described in PTL 1 can image the motion of an operator (test subject) to evaluate differences between the imaged motion and a reference motion, the technology fails to evaluate the motion of each operator efficiently using the image data acquired of the motions of multiple operators, for example.

Also, according to the technology described in PTL 1, it is difficult to efficiently analyze data over an extended time period (e.g., for several hours to several days). For example, in a case where the image data acquired for a long time in the past is analyzed collectively to evaluate motions, the technology of PTL 1 is subject to an inordinately high processing load because of the need to compare the motions represented visually by the image data with each of multiple reference motions to be compared.

It is under the above circumstances that the discloser of the present disclosure has devised the technology described herein. An information processing apparatus according to one embodiment of the present disclosure analyzes the data recorded of the motions of multiple users so as to estimate the motions, adds tag data regarding the estimated motions to at least part of the recorded data, and evaluates the motions by comparing the motions with reference motions on the basis of the tag data.

In this manner, the information processing apparatus of the present embodiment can evaluate the motions of multiple users more efficiently. For example, in a case where multiple users performing various motions are imaged, the information processing apparatus of the present embodiment can evaluate the motion of each user more efficiently by analyzing the image data representing visually the multiple users.

Here, the information processing apparatus according to the present embodiment may be used in conjunction with a training system employed in a gym, for example. Explained more specifically, during training in the gym, a user most often does the training alone unless the user hires a personal coach. Thus, if the user is not familiar with the training (or with the use of training equipment), the user may not obtain the benefits of the training or may even get injured because of the ignorance of a normal form, an appropriate load, or a suitable amount of training. When the information processing apparatus of the present embodiment is utilized in conjunction with the training system in the gym, the information processing apparatus evaluates the training of each user more efficiently by analyzing the image data representing visually multiple users in training (incidentally, not just the image data but other data as well). This enables the information processing apparatus to detect users doing their training in an ineffective manner, or users training in a dangerous form or method.

Also, given the data recorded of the motions of multiple users, the information processing apparatus according to the present embodiment adds tag data regarding the motions to at least part of the recorded data. This allows the information processing apparatus to analyze more effectively the data over a long time period (e.g., for several hours to several days). For example, in a case where the image data acquired for a long time in the past is analyzed collectively to evaluate motions, the information processing apparatus of the present embodiment can smoothly recognize reference motions for use in comparison with the motions of the users on the basis of the tag data added to the image data. This enables the information processing apparatus of the present embodiment to compare more efficiently the users' motions with the reference motions given the image data over a long time period (e.g., for several hours to several days).

Incidentally, the information processing apparatus according to the present embodiment may also be used in conjunction with diverse systems other than the training system in the gym. For example, the information processing apparatus of the present embodiment may be used by information processing systems set up in such establishments as nursing homes, hospitals, schools, companies, and shops. Thus installed, the information processing apparatus of the present embodiment analyzes the motions of multiple residents (users) in a nursing home to detect residents in poor condition, or analyzes the motions of multiple customers (users) in a shop to detect customers with suspicious behavior, for example. Further, although it is explained above that the data to be analyzed is the image data, for example, the type of the data to be analyzed is not limited to anything specific. For example, the data to be analyzed may come from inertial sensors including acceleration sensors and gyro sensors (IMU: Inertial Measurement Unit).

### 2. CONFIGURATION EXAMPLES

### 2.1 Configuration Example of Information Processing System

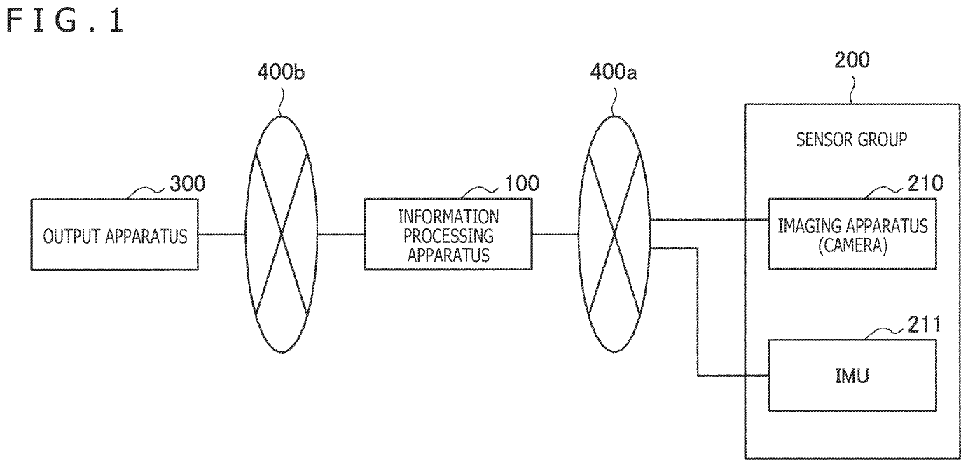

The preceding paragraphs explain an overview of the present disclosure. Explained below with reference to FIG. 1 is a configuration example of the information processing system according to the present embodiment. FIG. 1 is a block diagram depicting a configuration example of the information processing system according to the present embodiment. Incidentally, as explained above, whereas the information processing apparatus of this embodiment may be used in conjunction with diverse systems, what is explained below is a case where the information processing apparatus according to the present embodiment is utilized by the training system in the gym, for example.

As depicted in FIG. 1, the information processing system according to the present embodiment includes an information processing apparatus 100, a sensor group 200, and an output apparatus 300. Further, the sensor group 200 includes an imaging apparatus 210 (camera) and an IMU 211. The information processing apparatus 100, the imaging apparatus 210, and the IMU 211 are interconnected via a network 400a. The information processing apparatus 100 and the output apparatus 300 are connected with each other via a network 400b (In the description that follows, the term “network 400” will be used to designate both the network 400a and the network 400b where they are mentioned collectively).

(Sensor Group 200)

The sensor group 200 is a group of sensors that record the motions of multiple users doing their training in the gym, for example, before outputting the recorded data. The imaging apparatus 210 is installed in the gym in a manner permitting the imaging of the motions of multiple users. The image data output from the imaging apparatus 210 is used by the information processing apparatus 100 in analyzing the motions of the users. Whereas it is preferred that multiple imaging apparatuses 210 be installed so as to image the motion of each user from various angles, the number of the imaging apparatuses 210 is not limited to any specific number (there may be a single imaging apparatus 210). Further, the imaging apparatus 210 may be a monocular type or a binocular type. Where a monocular-type imaging apparatus 210 is adopted, the existing imaging apparatus currently in place may be used effectively as is. More specifically, in a case where the monocular-type imaging apparatus (e.g., security camera) is already installed, that imaging apparatus may be utilized as the imaging apparatus 210 according to the present embodiment. This permits easier introduction of the information processing system according to the present embodiment. Further, where a binocular-type imaging apparatus 210 is adopted, it is possible more easily to calculate a separation distance from the apparatus to the subject. This provides for easier analysis of the motion of a user.

The IMU 211 includes an acceleration sensor and a gyro sensor (angular velocity sensor), for example. When attached to the bodies of multiple users, the sensors output acceleration data and angular velocity data regarding different body parts of the users. The acceleration data and the angular velocity data output from the IMU 211 are used by the information processing apparatus 100 in analyzing the motions of the users. Alternatively, the IMU 211 may be attached to parts other than the bodies of multiple users. More specifically, the IMU 211 may be attached to physical objects used by the users in motion, such as the equipment for training purposes, for example. The acceleration data and angular velocity data output from the IMU 211 installed in this manner may be used to determine whether or not the equipment is currently used for training or to estimate how the equipment is being utilized. Further, the apparatuses included in the sensor group 200 are not limited to the imaging apparatus 210 and the IMU 211.

(Information Processing Apparatus 100)

The information processing apparatus 100 functions as the above-described “information processing apparatus according to the present embodiment.” More specifically, the information processing apparatus 100 analyzes the data output from the sensor group 200 (e.g., image data output from the imaging apparatus 210) so as to estimate the motions of multiple users, add tag data regarding the motions to at least part of the output data, and evaluates the estimated motions of the users by comparing the motions of interest with reference motions on the basis of the tag data.

In this manner, the information processing apparatus 100 can evaluate the motions of multiple users more efficiently. More specifically, the information processing apparatus 100 analyzes the image data representing visually multiple users doing training in order to evaluate the training of each user more efficiently. This enables the information processing apparatus 100 to detect users doing training in an ineffective manner, or users training in a dangerous form or method. The information processing apparatus 100 then controls the output of the output apparatus 300 on the basis of the result of motion evaluation. The processing by the information processing apparatus 100 will be discussed later in detail.

Incidentally, the type of the information processing apparatus 100 is not limited to anything specific. For example, the information processing apparatus 100 may be implemented using any one of diverse servers, a general-purpose computer, a PC (Personal Computer), a tablet PC, or a smartphone.

(Output Apparatus 300)

The output apparatus 300 provides various kinds of output under control of the information processing apparatus 100. For example, in a case where information processing apparatus 100 has detected a user doing training in an ineffective manner or a user training in a dangerous form or method, the output apparatus 300 provides output to notify the user in question or some other person (e.g., trainer in the gym) of the current situation. This provides an appropriate feedback to the user even in a case where the number of trainers is limited.

Incidentally, the timing at which the output apparatus 300 provides output and the details of the output are not limited to the specifics mentioned above. For example, the output apparatus 300 may output diverse information based on the input from the user operating the output apparatus 300 (e.g., where the input is made to search for and select desired data). Further, the type of the output apparatus 300 is not limited to anything specific. For example, whereas the output apparatus 300 is assumed to have a display function, this is not limitative of the output apparatus 300. Alternatively, the output apparatus 300 may be equipped with an audio output function or the like. Further, the output apparatus 300 may be a mobile apparatus (e.g., a tablet PC or a smartphone) or an apparatus secured to the wall surface or to the ceiling (e.g., a TV set or a display apparatus).

(Network 400)

The network 400 interconnects the above-described apparatuses by appropriate communication channels. The communication method or the channel type used by the network 400 is not limited to anything specific. For example, the network 400 may be implemented using a leased line network such as IP-VPN (Internet Protocol-Virtual Private Network), a public network such as the Internet, a telephone network, or a satellite communication network, any of diverse LANs (Local Area Network) or WANs (Wide Area Network) including Ethernet (registered trademark), or a wireless communication network such as Wi-Fi (registered trademark) or Bluetooth (registered trademark).

A configuration example of the information processing system according to the present embodiment is explained above. It is to be noted that the configuration explained above with reference to FIG. 1 is only an example and that the configuration of the information processing apparatus of the present embodiment is not limited thereto. For example, the functions of the constituent apparatuses may be implemented using other apparatuses. More specifically, part or all of the functions of the output apparatus 300 may be implemented by the information processing apparatus 100. The configuration of the information processing system according to this embodiment may be varied flexibly in accordance with the specifications and operations involved.

### 2.2 Configuration Example of Information Processing Apparatus

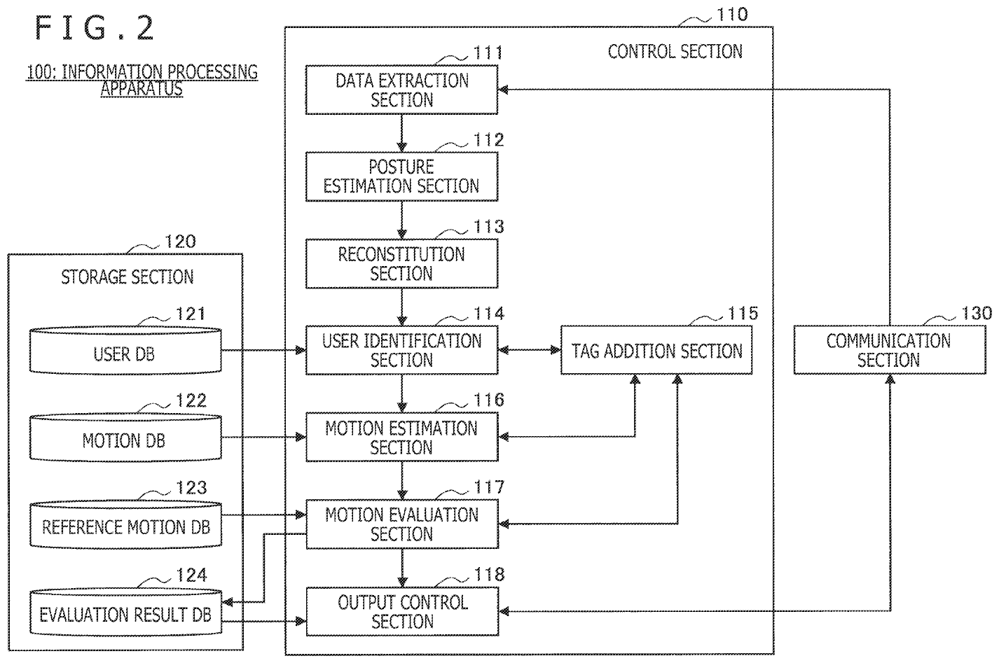

Explained next with reference to FIG. 2 is a configuration example of the information processing apparatus 100 according to the present embodiment. FIG. 2 is a block diagram depicting a configuration example of the information processing apparatus 100 according to this embodiment.

As depicted in FIG. 2, the information processing apparatus 100 according to the present embodiment includes a control section 110, a storage section 120, and a communication section 130. Further, the control section 110 includes a data extraction section 111, a posture estimation section 112, a reconstitution section 113, a user identification section 114, a tag addition section 115, a motion estimation section 116, a motion evaluation section 117, and an output control section 118. Further, the storage section 120 includes a user DB 121, a motion DB 122, a reference motion DB 123, and an evaluation result DB 124.

(Control Section 110)

The control section 110 is configured to control integrally the entire processes performed by the information processing apparatus 100. For example, the control section 110 controls start and stop of each constituent element of the information processing apparatus 100. Incidentally, the details of the control by the control section 110 are not limited to anything specific. For example, the control section 110 may control processes (e.g., those of OS (Operating System)) that are generally performed by any of various servers, a general-purpose computer, a tablet PC, or a smartphone.

(Data Extraction Section 111)

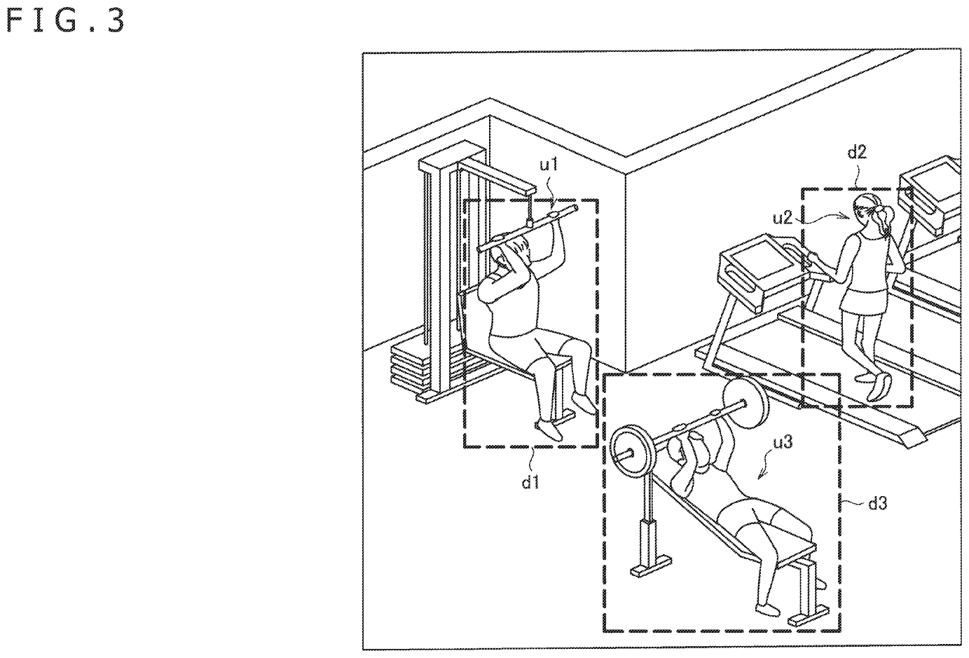

The data extraction section 111 is configured to extract data regarding the motion of each user from the data supplied from the sensor group 200. For example, as depicted in FIG. 3, consider a case where the imaging apparatus 210 supplies image data representing visually the motions of users u1 through u3 doing training in the gym. In this case, the data extraction section 111 analyzes the image data so as to identify regions in the image data representing visually the motions of the users u1 through u3, thereby extracting image data d1 through d3 of a given shape each (e.g., rectangle) that include the identified regions. Incidentally, the method of analyzing the image data to identify the regions representing visually the motion of each user is not limited to anything specific, and known image recognition processes may be carried out for the analysis.

Further, in a case where the data supplied from the sensor group 200 is data other than the image data, the data extraction section 111 performs processes corresponding to the data type in order to extract the data regarding the motion of each user. For example, in a case where the data supplied from the sensor group 200 constitutes acceleration data and angular velocity data regarding different body parts of multiple users, the data extraction section 111 divides the data by user. The data extraction section 111 supplies the extracted data to the posture estimation section 112. It is to be noted that the above processes are only examples and that the details of the processes performed by the data extraction section 111 are not limited to these specifics.

(Posture Estimation Section 112)

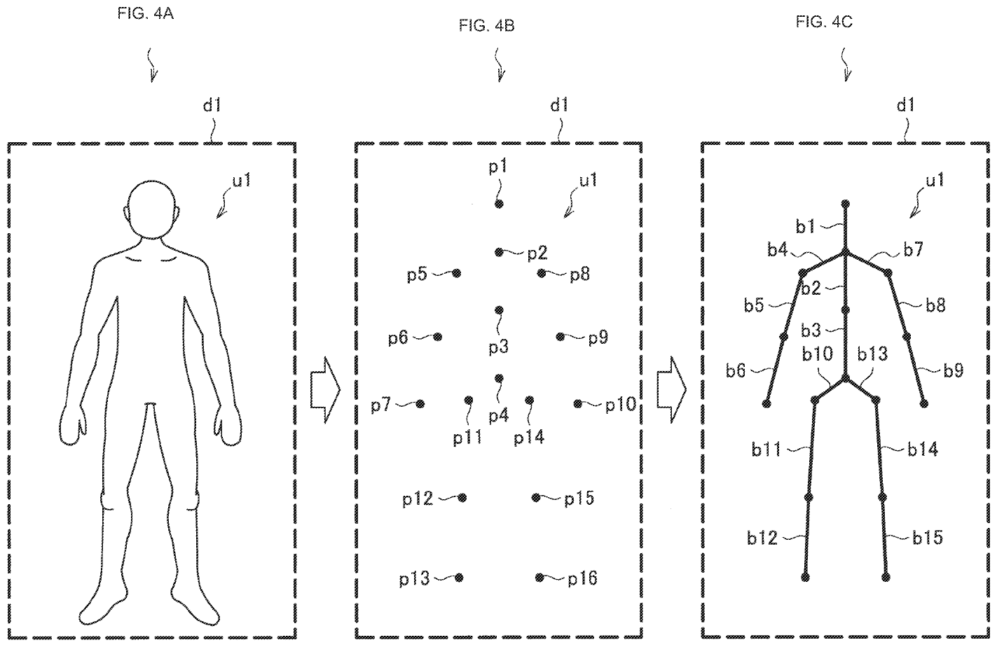

The posture estimation section 112 is configured to estimate the posture of each user by analyzing the data extracted by the data extraction section 111. A specific example of a posture estimation process performed by the posture estimation section 112 is explained herein with reference to FIG. 4. FIG. 4 is a diagram illustrating the case in which the posture estimation section 112 estimates the posture of a user by use of image data.

Subfigure A in FIG. 4 depicts image data extracted by the data extraction section 111 (the example in FIG. 4 is the image data d1 representing visually the motion of the user u1). By analyzing the image data d1, the posture estimation section 112 outputs the positions of given parts p1 through p16 (e.g., given relevant joints) of the user u1 represented by the image data d1, as depicted in Subfigure B in FIG. 4. The posture estimation section 112 then outputs bones b1 through b15 interconnecting the parts p1 through p16, as indicated in Subfigure C in FIG. 4. On the basis of the positions and postures of the bones, the posture estimation section 112 estimates the posture of the user u1. In the ensuing paragraphs, the information regarding the postures estimated by the posture estimation section 112 (e.g., including information regarding the positions and postures of the bones) will be referred to as “posture information.”

Incidentally, whereas the parts of which the positions are output as depicted in Subfigure B in FIG. 4 should preferably include the joints of the shoulders, arms, hands, legs, neck, and the like to facilitate estimation of the user's posture, it is not mandatory for these parts to be included. Further, the larger the number is of the parts of which the positions are output as indicated in Subfigure B in FIG. 4, the easier it is to estimate the posture of the user. However, the number of these parts is not limited to any specific number.

Further, in a case where the data supplied from the sensor group 200 is data other than the image data, the posture estimation section 112 estimates the posture of each user by performing processes corresponding to the type of the supplied data. For example, in a case where the data supplied from the sensor group 200 constitutes the acceleration data and angular velocity data output from the IMU 211 regarding the parts of the user, the posture estimation section 112 calculates the position of each of the parts by performing processes such as inertial navigation using these data. By correcting drift errors stemming from the processing using a regression model, for example, the posture estimation section 112 outputs a highly accurate position and posture of each of the parts. Further, the posture estimation section 112 outputs bones such as those depicted in Subfigure C in FIG. 4 (the output bones may or may not be the same as those illustrated in Subfigure C in FIG. 4) by use of inverse kinematics (IK) calculation. The posture estimation section 112 supplies the output posture information to the reconstitution section 113.

It is to be noted that the above-described processing is only an example and that the specifics of the processing performed by the posture estimation section 112 are not limited to those discussed above. For example, the posture estimation section 112 may output a shape (body type) by analyzing the image data. More specifically, the posture estimation section 112 may extract a contour of the user from the image data and estimate the shape without the user's clothes on the basis of the estimated contour. This enables the output control section 118, to be discussed later, to cause the output apparatus 300 to output changes in the shape over time, thereby visually demonstrating the effects of the training.

(Reconstitution Section 113)

The reconstitution section 113 is configured to reconstitute each user in a three-dimensional coordinate system using the posture information output from the posture estimation section 112. For example, based on the position of the imaging apparatus 210 (imaging position) as well as on each user and the background represented visually by the image data, the reconstitution section 113 recognizes the positional relation between a given origin O of the three-dimensional coordinate system and each user. In a case where there are multiple imaging apparatuses 210, the reconstitution section 113 recognizes the positional relation between the origin O of the three-dimensional coordinate system and each user based on the position of each imaging apparatus 210 (multiple imaging positions) as well as on each user and the background represented visually by the image data generated by each imaging apparatus 210. Then, the reconstitution section 113 reconstitutes each user in the three-dimensional coordinate system on the basis of the positional relation between the origin O and each user. This enables the reconstitution section 113 to output three-dimensional coordinates of each of the parts of each user.

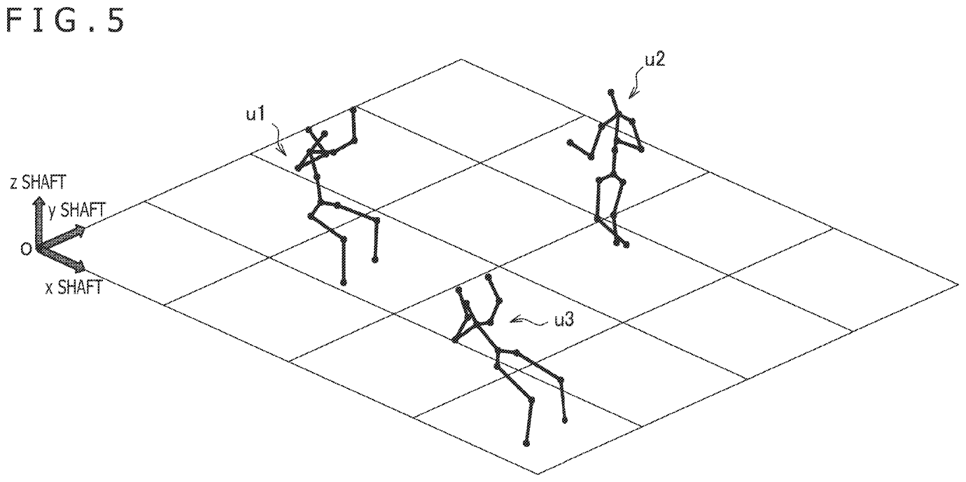

Here, FIG. 5 is a diagram illustrating each user reconstituted by the reconstitution section 113 in a three-dimensional coordinate system. As depicted in FIG. 5, for example, the reconstitution section 113 reconstitutes the users u1 through u3 found in FIG. 3 in the three-dimensional coordinate system with its origin at point O. It is to be noted that the above processing is only an example and that the specifics of the processing performed by the reconstitution section 113 are not limited to those discussed above. For example, in a case where a position sensor is attached to each of the users, the reconstitution section 113 may, on the basis of sensor data from the position sensors, recognize the positional relation between the given origin O of the three-dimensional coordinate system and each user.

(User Identification Section 114)

The user identification section 114 is configured to identify each user. More specifically, the user DB 121, to be discussed later, stores beforehand the information indicative of the feature of the user's body (e.g., face) represented by the image data (the information indicative of such features will be referred to as “feature quantity” hereunder). The user identification section 114 then calculates the feature quantity of the image data generated by the imaging apparatus 210 and compares the calculated feature quantity with the feature quantities of the users stored in the user DB 121 to identify the user given as the subject.

Incidentally, the method of identifying the user is not limited to the method discussed above. For example, in a case where a user is equipped with an apparatus having a recorded user ID for identifying the user, the user identification section 114 may identify the user by acquiring the user ID from the apparatus attached to the user by way of the communication section 130. The user identification section 114 supplies the information regarding the identified user to the tag addition section 115.

(Tag Addition Section 115)

The tag addition section 115 is configured to add tag data to at least part of the data recorded of the motions of multiple users. For example, in a case where the data supplied from the sensor group 200 is image data, the tag addition section 115 adds the tag data to the image data extracted by the data extraction section 111 (in other words, the tag data is added to part of the data recorded of the motions of multiple users).

The tag data to be added by the tag addition section 115 includes, for example, tag data regarding the motion of the user estimated by the motion estimation section 116 connected downstream (e.g., including tag data indicative of the motion, tag data indicative of motion status, tag data indicative of the timing and position at which the motion is performed, and tag data indicative of evaluation of the motion), tag data regarding the user identified by the user identification section 114 (e.g., tag data indicative of the user, tag data indicative of a user attribute, or tag data indicative of user status), or tag data regarding the data generated by the sensor group 200 (e.g., tag data indicative of the sensor having generated the data, or tag data indicative of the timing at which the data is generated).

FIG. 6 is a diagram depicting specific examples of tag data. FIG. 6 indicates, as the tag data, “data generation start timing,” “establishment ID,” “user ID,” “training type,” “motion status,” and “evaluation.” The “data generation start timing” is the tag data indicative of the timing at which the data is generated. For example, this is the timing at which generation of a series of image data representing visually the motion of a given user is started. The “establishment ID” is the tag data indicative of the position where the motion is performed. For example, this is the ID of the gym. The “user ID” is the tag data identifying the user. The “training type” is the tag data indicative of the motion. The “motion status” is the tag data indicative of the motion status of the user. For example, the motion status indicates the status of the user from a motion point of view, such as “in training,” “while resting,” “while walking,” “while eating and drinking,” or “while sleeping.” The “evaluation” is the tag data indicative of the evaluation of the motion. For example, this is quantitative or qualitative information indicative of the degree of normality or the level of danger. It is to be noted that the types and specifics of the tag data are not limited to the examples indicated in FIG. 6.

In a case where the user identification section 114 identifies the user represented visually by the image data, the tag addition section 115 adds to the image data the tag data such as a user ID, for example, based on the information supplied from the user identification section 114 regarding the user. Further, in a case where the motion estimation section 116, to be discussed later, estimates the motion represented visually by the image data, the tag addition section 115 adds to the image data the tag data such as the training type and motion status based on the information supplied from the motion estimation section 116 regarding the motion. Further, in a case where the motion evaluation section 117, to be discussed later, evaluates the motion represented visually by the image data, the tag addition section 115 adds to the image data the tag data such as the evaluation, for example, based on the information supplied from the motion evaluation section 117 regarding the motion. Then, the tag addition section 115 returns the data supplemented with the tag data to the individual constituent components.

By adding the tag data to the data as described above, the tag addition section 115 enables implementation of the analysis of the data in a more efficient manner over an extended time period (e.g., for several hours to several days). For example, in a case where the image data acquired for a long time in the past is analyzed collectively to evaluate motions, the motion evaluation section 117, to be discussed later, can smoothly recognize the reference motion to be compared with the motion of a user based on the tag data added to the image data. This enables the motion evaluation section 117, given the image data covering a long time period, to compare the user's motion with the reference motion more efficiently.

Further, with the tag data added to the data, more efficient acquisition of desired data is implemented. More specifically, by designating the tag data, the output control section 118, to be discussed later, can easily search for and acquire the data to be output from among large amounts of data. This makes it easy to implement coaching based on previously acquired data, for example. More specifically, if all motions of the users having done training in the gym are stored as image data, it is difficult for trainers to verify the image data one item at a time. By contrast, where the tag data is added to the image data as in the present embodiment, the trainer may designate the tag data such as a user ID or a training type, thereby causing the output control section 118 to output the image data representing visually the desired user or training motion, for example. This makes it possible to implement coaching with a smaller number of trainers. At the same time, in a case where there is a specialized trainer for each training type (e.g., a trainer specializing in running, a trainer specializing in weight training, etc.), each specialized trainer can acquire only the image data representing visually the training motion in his or her field of specialization for coating purposes. This also makes it easier to implement remote coaching via networks, for example.

(Motion Estimation Section 116)

The motion estimation section 116 is configured to estimate the motion of interest by analyzing the data recorded of the motions of multiple users. More specifically, the motion DB 122, to be discussed later, stores the feature quantity of each of the motions beforehand. For example, the motion DB 122 stores beforehand the feature quantities of changes over time in the posture information regarding each motion. The motion estimation section 116 then estimates the motion of a user by making comparisons between the feature quantities of changes over time in the posture information output from the posture estimation section 112 on one hand, and the feature quantities of changes over time in the posture information regarding each motion stored in the motion DB 122 on the other hand. Thereafter, as described above, the motion estimation section 116 supplies the tag addition section 115 with the information regarding the estimated motion, so that the tag addition section 115 may add the tag data regarding the motion (e.g., training type and motion status).

Incidentally, the method of estimating the motion is not limited to the method discussed above. For example, the motion estimation section 116 may estimate the motion of a user on the basis of the user's position or the equipment utilized by the user. For example, in a case where the position of the training equipment is fixed as in the gym, the training motion can be estimated on the basis of the user's position. Thus, the motion estimation section 116 may identify the user's position based on the sensor data from a position sensor (not depicted) attached to the user, for example, and, on the basis of the position thus identified, estimate the motion of the user. Further, in a case where the training equipment is furnished with the IMU 211, for example, the motion estimation section 116 may, on the basis of the sensor data from the IMU 211, determine whether or not the equipment is currently used for training or estimate how the equipment is being utilized so as to estimate the user's motion.

(Motion Evaluation Section 117)

The motion evaluation section 117 is configured to evaluate the motion of a user by comparing the user's motion with the reference motion on the basis of tag data. Furthermore, by comparing the user's motion with the reference motion, the motion evaluation section 117 outputs values for permitting the evaluation of whether or not the user's motion is abnormal. More specifically, the reference motion DB 123, to be discussed later, stores beforehand the feature quantities of the reference motion relative to each motion. For example, the reference motion DB 123 stores the feature quantities of changes over time in the posture information regarding the reference motions. The motion evaluation section 117 evaluates the user's motion by making comparisons between the feature quantities of changes over time in the posture information output from the posture estimation section 112 on one hand, and the feature quantities of changes over time in the posture information regarding the reference motion stored in the reference motion DB 123 on the other hand.

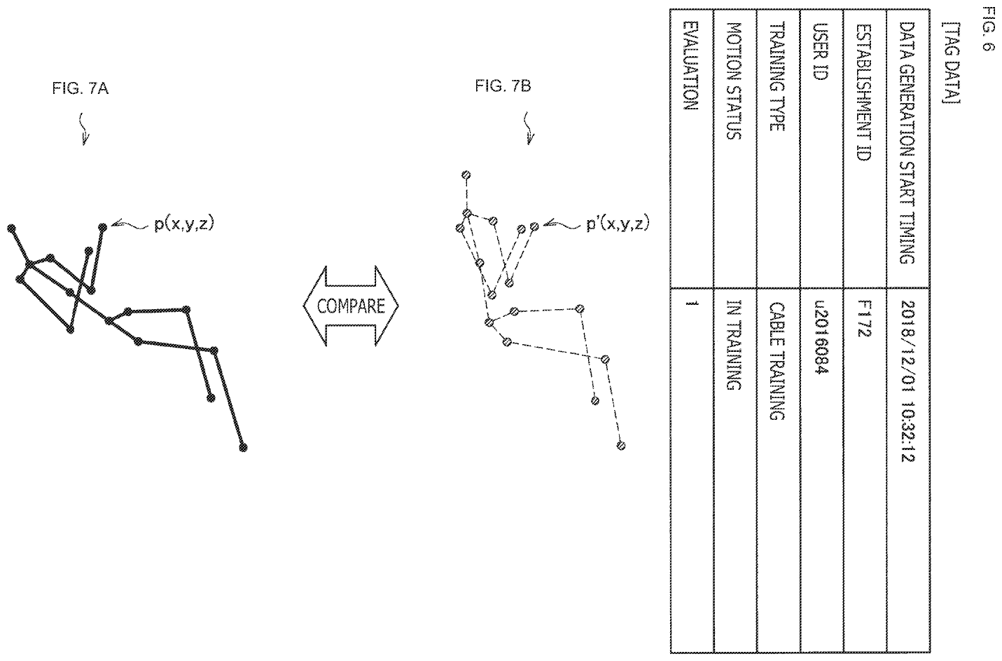

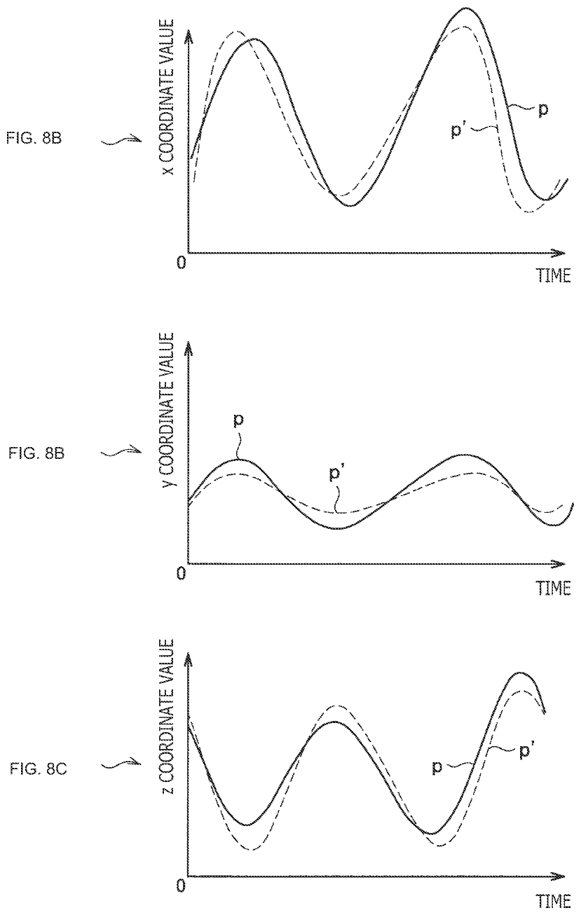

FIGS. 7 and 8 are diagrams for explaining a motion evaluation process performed by the motion evaluation section 117. Subfigure A in FIG. 7 depicts the posture information at a given timing, and Subfigure B in FIG. 7 illustrates the position information regarding the reference motion to be compared. The motion evaluation section 117 analyzes the changes over time both in a part p in Subfigure A in FIG. 7 and in a part p′ corresponding to the part p and found in Subfigure B in FIG. 7. For example, as depicted in Subfigures A through C in FIG. 8, the motion evaluation section 117 compares between the parts p and p′ the changes over time in the values of x, y, and z coordinates thereof, thereby calculating the degree of similarity therebetween. The motion evaluation section 117 performs the above process on all parts in the posture information and, on the basis of an overall degree of similarity therebetween, evaluates the user's motion.

Here, the “reference motions” include a normal, ideal, or abnormal motion, or a motion performed by the user in the past, with respect to the motion estimated by the motion estimation section 116. In a case where the reference motion is a normal or ideal motion, the motion evaluation section 117 evaluates differences between the motion of the user doing training on one hand and the normal or ideal motion on the other hand. This enables the motion evaluation section 117 to implement more easily a feedback for bringing the user's motion closer to the normal or ideal motion, for example. Further, in a case where the reference motion is an abnormal motion, the motion evaluation section 117 evaluates differences between the motion of the user doing training on one hand and the abnormal motion on the other hand. This enables the motion evaluation section 117 to determine more easily whether or not the user's motion is dangerous, for example. In a case where the reference motion is a motion performed by the user in the past, the motion evaluation section 117 evaluates differences between the motion of the user doing training on one hand and the motion performed previously by the user on the other hand. This enables the motion evaluation section 117 to output more easily the changes in training skill.

There may be cases where the features of each reference motion vary under diverse conditions. For example, the features of each reference motion (e.g., velocity of motion, and angle of each part) may vary depending on the user's age, gender, or training plan (e.g., necessary loads). In such cases, the motion evaluation section 117 may recognize the various conditions under which training is performed using various methods, and change the reference motion to be used in the process of motion evaluation under the recognized conditions. The method of recognizing the conditions under which training is performed is not limited to anything specific. For example, the motion evaluation section 117 may acquire the user's age, gender, or training plan by communicating with a device (e.g., smartphone) owned by the user via the communication section 130. Further, in a case where the training equipment (e.g., dumbbells of different weights) is furnished with the IMU 211, for example, the motion evaluation section 117 may recognize the loads of training on the basis of the sensor data from the IMU 211.

Further, the “motions” evaluated by the motion evaluation section 117 include “form” regarding training or sports. For example, the motion evaluation section 117 can evaluate differences between the form of the user doing training on one hand, and a normal, ideal, or abnormal form, or the form of the user in the past on the other hand.

Thereafter, as described above, the motion evaluation section 117 supplies the information regarding the motion evaluation to the tag addition section 115, so that the tag addition section 115 may add the tag data regarding the motion evaluation. Further, the motion evaluation section 117 supplies the information regarding the motion evaluation to the output control section 118 and also stores it into the evaluation result DB 124.

Incidentally, the method of evaluating the motions is not limited to the above-described method. For example, the motion evaluation section 117 may evaluate the motions using machine learning technology or artificial intelligence technology. More specifically, the motion evaluation section 117 may obtain the result of motion evaluation as the output by inputting the posture information to at least either a machine learning algorithm or an artificial intelligence algorithm. Here, the machine learning algorithm or the artificial intelligence algorithm may be generated by a machine learning method such as a neural network or a regression model or by a statistical method, for example. In the case of the machine learning method, for example, learning is performed by inputting learning data that associates the result of motion evaluation with the posture information to an appropriate calculation model using a neural network or a regression model. A processing circuit having a processing model with the parameters thus generated may implement the functions of the machine learning algorithm or the artificial intelligence algorithm of interest. Incidentally, the method of generating the machine learning algorithm or the artificial intelligence algorithm is not limited to the method described above. Furthermore, besides the process of motion evaluation performed by the motion evaluation section 117, machine learning technology or artificial intelligence technology may be used to implement other processes including the posture estimation process performed by the posture estimation section 112, the process of reconstitution in a three-dimensional coordinate system performed by the reconstitution section 113, the process of user identification process by the user identification section 114, and the process of motion estimation by the motion estimation section 116 (these processes are not limitative of the processes that may be implemented).

(Output Control Section 118)

The output control section 118 is configured to control the output of the result of motion evaluation from the own apparatus or from the output apparatus 300 (external apparatus). For example, in a case where the training motion of a user is evaluated as abnormal (e.g., a dangerous motion), the output control section 118 may cause the output apparatus 300 to display a warning notifying the user or some other person (e.g., trainer in the gym) that an abnormal motion has occurred.

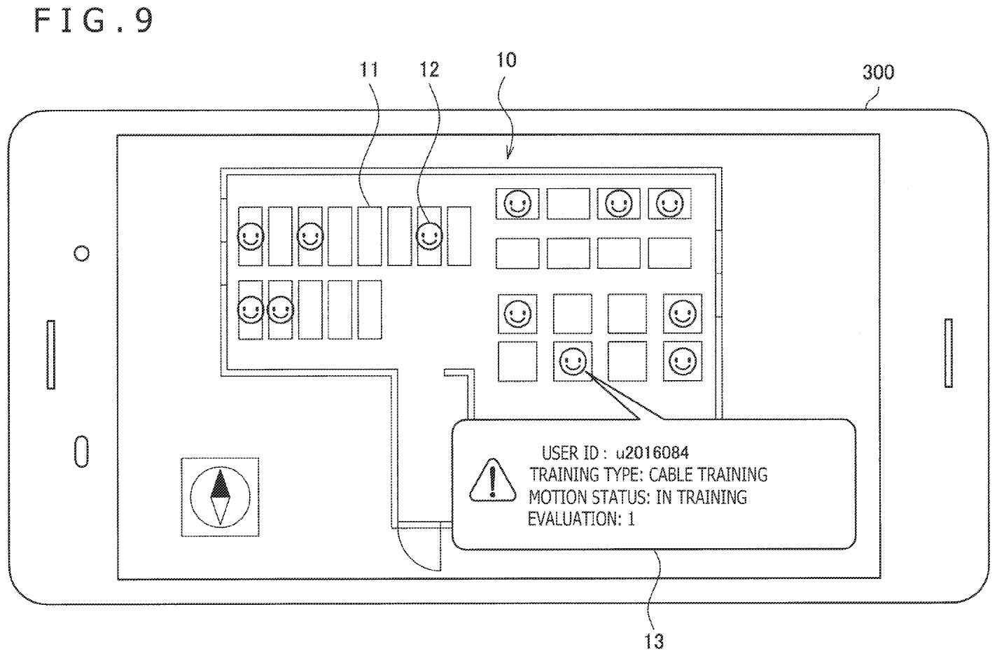

FIG. 9 is a diagram depicting a specific example of image data displayed on the output apparatus 300 to notify that an abnormal motion has occurred (in the example of FIG. 9, the output apparatus 300 is a smartphone). In the example of FIG. 9, the display screen of the output apparatus 300 displays a room layout 10 of the gym and training equipment symbols 11 denoting various training equipment. A user symbol 12 is attached to the training equipment symbol 11 corresponding to the training equipment currently used by the user. In a case where the training motion of the user is evaluated as an abnormal motion, the output control section 118 may cause the output apparatus 300 to display a warning 13 indicating the user in question. In the example of FIG. 9, the warning 13 is shaped to be a balloon pointing to the user of interest. The balloon includes tag data such as the user ID, training type, motion status, and evaluation. Viewing the warning 13 allows the user in person or some other person (e.g., trainer in the gym) to easily recognize the occurrence of an abnormal motion, the identity of the user doing the abnormal motion, and the position where the abnormal motion has occurred. The information caused to be displayed on the output apparatus 300 by the output control section 118 is not limited to the example in FIG. 9. Incidentally, variations of the information displayed on the output apparatus 300 by the output control section 118 will be discussed later in detail. Further, the output control section 118 may cause the output apparatus 300 not only to display information but also to output sounds or to light lamps (obviously, these modes of output are not limitative of how the output can be performed).

Furthermore, on the basis of the tag data designated from the outside, the output control section 118 may acquire from the evaluation result DB 124 the data supplemented with the tag data, and control the own apparatus or the output apparatus 300 (external apparatus) to perform the output accordingly. That is, the output control section 118 can easily acquire the desired data from among large amounts of data by use of the tag data, and control each apparatus to perform the output using the acquired data. This allows the user in person or some other person (e.g., trainer in the gym) to easily verify the desired data using the output apparatus 300, for example. For example, the user can perform training while verifying historical data (e.g., previous posture information and evaluation results) regarding the training conducted by the user in the past.

(Storage Section 120)

The storage section 120 is configured to store diverse information. For example, the storage section 120 stores the programs and parameters to be used by the constituent elements of the control section 110. Also, the storage section 120 may store the results of the processes performed by the constituent elements of the control section 110 as well as the information received from the external apparatus by way of the communication section 130 (e.g., sensor data received from the sensor group 200). It is to be noted that such information is not limitative of the information that may be stored in the storage section 120.

(User DB 121)

The user DB 121 stores the information for identifying each user. More specifically, the user DB 121 stores the feature quantities of the body parts of each user (e.g., feature quantities of each user's body (e.g., face) in the image data). Using the information thus stored allows the user identification section 114 to identify the users.

Further, in a case where a device with a user ID recorded therein is attached to each user and where communication with that device allows the user ID to be acquired for user identification, the user DB 121 may store the user ID or the like assigned to each user. It is to be noted that such information is not limitative of the information that may be stored in the user DB 121. For example, the user DB 121 may store attribute information regarding each user (e.g., name, address, contact, gender, and blood type).

(Motion DB 122)

The motion DB 122 stores the information for use in estimating each motion. More specifically, the motion DB 122 stores the feature quantities of each motion. Using the information thus stored allows the motion estimation section 116 to estimate the motions of users. Here, the features of each motion may vary under various conditions. For example, the features of each motion may vary depending on the age and gender of the user (obviously, these are not limitative of the features). Thus, the motion DB 122 may store the feature quantities of each motion for each of different conditions with different features.

Further, in a case where each motion is estimated on the basis of the user's position or of the equipment used by the user, the motion DB 122 may store information regarding the position in which the user performs each motion or information regarding the equipment used for each motion, for example. Incidentally, such information is not limitative of the information that may be stored in the motion DB 122.

(Reference Motion DB 123)

The reference motion DB 123 stores the information for use in estimating each motion. More specifically, the reference motion DB 123 stores the feature quantities of the reference motion relative to each motion. Using this information enables the motion evaluation section 117 to evaluate the motions of users. Here, as discussed above, the features of each reference motion may vary under diverse conditions. For example, the features of each reference motion (e.g., velocity of motion and angle of each part) may vary depending on the user's age, gender, or training plan (e.g., necessary loads). Thus as with the above-described motion DB 122, the reference motion DB 123 may store the feature quantities of each reference motion with respect to each of the conditions with different features.

As discussed above, the reference motions include a normal, ideal, or abnormal motion, or a motion performed by the user in the past. In a case where a motion previously performed by the user is used as a reference motion, the reference motion DB 123 stores the information supplied from the constituent elements of the control section 110 with respect to the motion performed by the user in the past. Such information, it is to be noted, is not limitative of the information stored in the reference motion DB 123.

(Evaluation Result DB 124)

The evaluation result DB 124 stores the information regarding the motion evaluations output from the motion evaluation section 117. More specifically, the evaluation result DB 124 stores the data supplemented with various tag data including the tag data indicative of the motion evaluations. The information stored in the evaluation result DB 124 is used for output control by the output control section 118. For example, the information stored in the evaluation result DB 124 is used by the output apparatus 300 in controlling the display.

(Communication Section 130)

The communication section 130 is configured to communicate with the external apparatus. For example, the communication section 130 receives the sensor data from the sensor group 200, and transmits information for display use to the output apparatus 300. It is to be noted that the information communicated via the communication section 130, the types of lines for use in communication, or the methods of communication are not limited to anything specific.

The preceding paragraphs describe the configuration example of the information processing apparatus 100. It is to be noted that the configuration explained above with reference to FIG. 2 and other drawings is only an example and is not limitative of how the information processing apparatus 100 is configured. For example, the information processing apparatus 100 need not include all constituent elements depicted in FIG. 2 and may include other constitute elements not illustrated therein.

### 3. PROCESS FLOW EXAMPLES

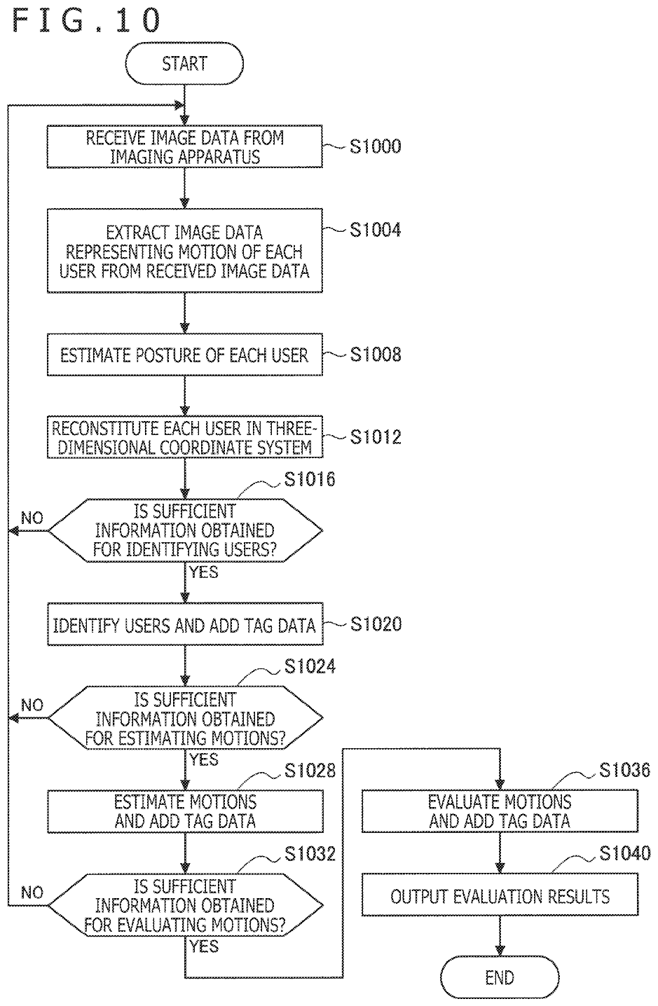

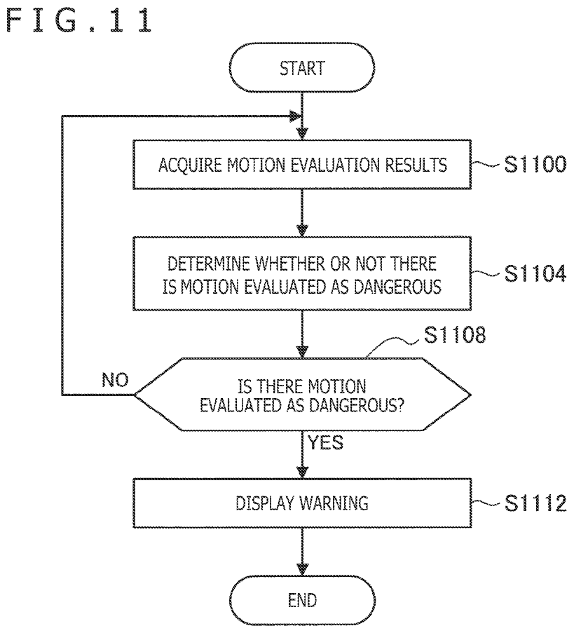

Described next with reference to FIGS. 10 and 11 are process flow examples of the information processing system according to the present embodiment.

FIG. 10 is a flowchart depicting a typical process flow ranging from acquisition of sensor data to output of the result of motion evaluation. In step S1000 in FIG. 10, the communication section 130 of the information processing apparatus 100 receives various sensor data from the sensor group 200. In the example of FIG. 10, the communication section 130 receives image data from the imaging apparatus 210.

In step S1004, the data extraction section 111 extracts from the image data the data representing visually the motion of each user. For example, the data extraction section 111 analyzes the image data to identify the region in the image data representing visually the motion of each user, and extracts the image data of predetermined shapes (e.g., rectangles) including the identified regions.

In step S1008, the posture estimation section 112 estimates the posture of each user by analyzing the image data extracted by the data extraction section 111. For example, the posture estimation section 112 outputs the positions of predetermined user body parts (e.g., relevant joint parts) in the image data, and outputs bones interconnecting these parts. By so doing, the posture estimation section 112 outputs the posture information indicative of the posture of each user.

In step S1012, the reconstitution section 113 reconstitutes each user in a three-dimensional coordinate system using the posture information output from the posture estimation section 112. For example, the reconstitution section 113 recognizes the positional relation between a given origin O in the three-dimensional coordinate system on one hand and each user on the other hand based on the position of the imaging apparatus 210 (imaging position) and on each user and the background represented visually by the image data. On the basis of the positional relation thus recognized, the reconstitution section 113 reconstitutes each user in the three-dimensional coordinate system.

In step S1016, in a case where sufficient information is obtained for recognizing the users represented visually by the image data (step S1016/Yes), step S1020 is reached. In step S1020, the user identification section 114 identifies the users, and the tag addition section 115 adds tag data regarding the users to the image data. For example, the user identification section 114 calculates the feature quantities of the image data and compares the calculated feature quantities with the feature quantities of each user stored in the user DB 121 so as to identify the users as the subjects. The tag addition section 115 then adds the tag data such as user IDs to the image data. Incidentally, in a case where sufficient information is not obtained for recognizing the users represented visually by the image data (step S1016/No), control is returned to step S1000. The subsequent steps are then repeated on another item of the image data (i.e., another frame).

In step S1024, in a case where sufficient information is obtained for recognizing the motions of the users (step S1024/Yes), step S1028 is reached. In step S1028, the motion estimation section 116 estimates the motions of the users, and the tag addition section 115 adds tag data regarding the estimated motions to the image data. For example, the motion estimation section 116 extracts the feature quantities of changes over time in the posture information output from the posture estimation section 112 and estimates the motions of the users by making comparisons between the extracted feature quantities on one hand and the feature quantities of each motion stored in the motion DB 122 on the other hand. The tag addition section 115 then adds to the image data the tag data such as the training types and motion status. Incidentally, in a case where sufficient information is not obtained for estimating the motions of the users (step S1024/No), control is returned to step S1000. The subsequent steps are then repeated on another item of the image data (i.e., another frame).

In step S1032, in a case where sufficient information is obtained for evaluating the motions of the users (step S1032/Yes), step S1036 is reached. In step S1036, the motion evaluation section 117 evaluates the motions of the users, and the tag addition section 115 adds tag data to the image data. For example, the motion evaluation section 117 extracts the feature quantities of changes over time in the posture information output from the posture estimation section 112 and evaluates the motions of the users by making comparisons between the extracted feature quantities on one hand and the feature quantities of the reference motions stored in the reference motion DB 123 on the other hand. The tag addition section 115 then adds the tag data indicative of the motion evaluations to the image data. Incidentally, in a case where sufficient information is not obtained for evaluating the motions of the users (step S1032/No), control is returned to step S1000. The subsequent steps are then repeated on another item of the image data (i.e., another frame).

In step S1040, the output control section 118 controls the output of the own apparatus or the output apparatus 300 (external apparatus) so as to implement the output of motion evaluation results.

The output of motion evaluation results is explained herein in more detail with reference to FIG. 11. FIG. 11 is a flowchart depicting in more detail the process of step S1040 in FIG. 10. In step S1100 in FIG. 11, the output control section 118 acquires from the motion evaluation section 117 (or from the evaluation result DB 124) the results of motion evaluations (e.g., image data supplemented with various tag data).

In step S1104, the output control section 118 determines whether or not there is a motion evaluated as a dangerous motion based on the tag data indicative of the motion evaluations added to the image data. In a case where there is a motion evaluated as a dangerous motion (step S1108/Yes), step S1112 is reached. In step S1112, the output control section 118 causes the output apparatus 300 or the like to display a warning notifying the user in person or some other person (e.g., trainer in the gym) that a dangerous motion has occurred. Incidentally, in a case where there is no motion evaluated as a dangerous motion (step S1108/No), control is returned to step S1100. The subsequent steps are then repeated on another item of the image data (i.e., another frame).

Incidentally, the steps in the flowcharts of FIGS. 10 and 11 need not be carried out chronologically as depicted in the flowcharts. That is, the steps in the flowcharts may be carried out in a sequence different from the described one or in parallel with one another (this similarly applies to other flowcharts, to be discussed later).

### 4. DISPLAY EXAMPLES

The process flow examples of the information processing apparatus according to the present embodiment are discussed above. Explained below are variations of the information that the output control section 118 of the information processing apparatus 100 causes the own apparatus or the output apparatus 300 (external apparatus) to display.

As discussed above, the output control section 118 may implement various types of output in addition to outputting the warning in the case where the user's motion is evaluated as an abnormal motion (e.g., dangerous motion) as depicted in FIG. 9.

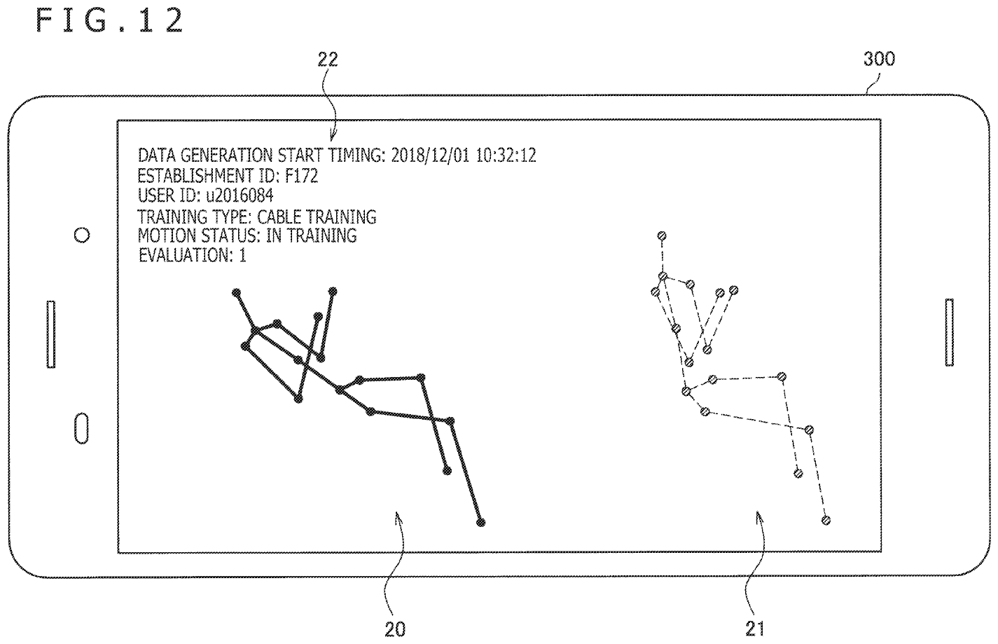

For example, the output control section 118 may cause the own apparatus or the output apparatus 300 (external apparatus) to display both first image data indicative of the motion of a user and second image data indicative of a corresponding reference motion. FIG. 12 depicts specific examples of first image data 20 and second image data 21 displayed on the output apparatus 300. In the examples in FIG. 12, the posture information output from the posture estimation section 112 is displayed as the first image data 20, and the posture information regarding the reference motion is displayed as the second image data 21. Further, tag data 22 added by the tag addition section 115 is displayed at the same time. When the first image data 20 and the second image data 21 are displayed side by side as depicted in FIG. 12, the person viewing the display can better recognize both the user's motion and the reference motion and make comparisons therebetween easily.

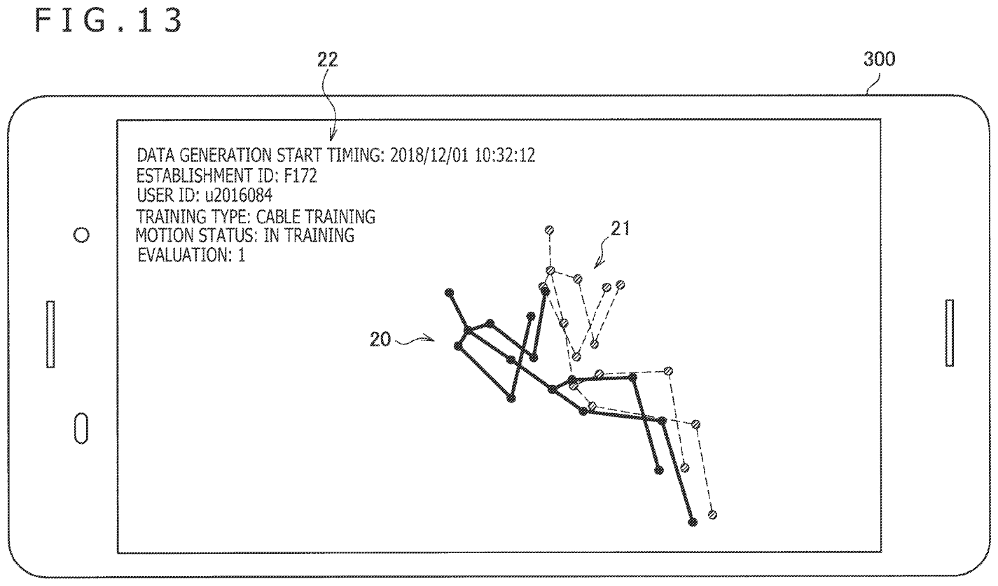

Further, the output control section 118 may cause the own apparatus or the output apparatus 300 (external apparatus) to display the first image data 20 and the second image data 21 overlaid on one another. FIG. 13 depicts a specific example of the first image data 20 and the second image data 21 being displayed overlaid on one another. When the first image data 20 and the second image data 21 are displayed overlaid on one another as depicted in FIG. 13, the person viewing the display can more easily recognize the differences between the user's motion and the reference motion.

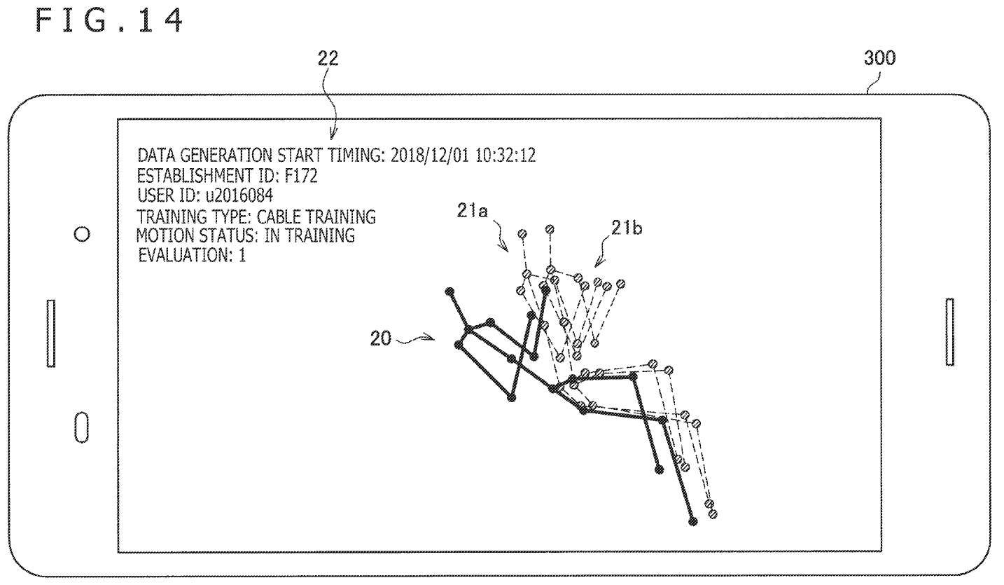

Alternatively, the output control section 118 may cause the own apparatus or the output apparatus 300 (external apparatus) to display two or more items of the second image data 21 along with the first image data 20. FIG. 14 depicts a specific example of multiple items of the second image data 21 (in the example of FIG. 14, second image data 21a and second image data 21b) displayed in an overlaid manner with respect to the first image data 20. In a case where there exist two or more reference motions to be compared (e.g., where the motions performed by the user at two or more different times in the past are used as the reference motions), two or more items of the second image data 21 indicative of these reference motions may be displayed in an overlaid manner with respect to the first image data 20. The person viewing this display can more easily recognize the differences between the user's motion on one hand and the two or more reference motions on the other hand.

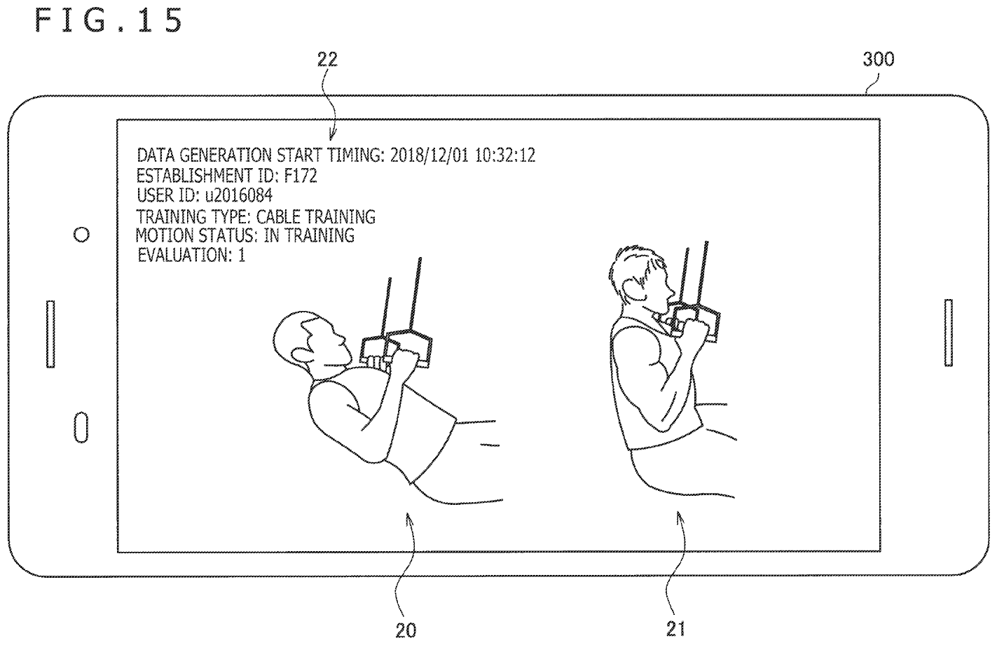

Also, the output control section 118 may display information other than the posture information as the first image data 20 and the second image data 21. For example, as depicted in FIG. 15, the output control section 118 may display part or all of the image data extracted by the data extraction section 111 as the first image data 20, and part or all of the image data acquired beforehand to represent the reference motion as the second image data 21. The display allows the user to recognize more easily such information as muscle movements that are difficult to recognize from the posture information.

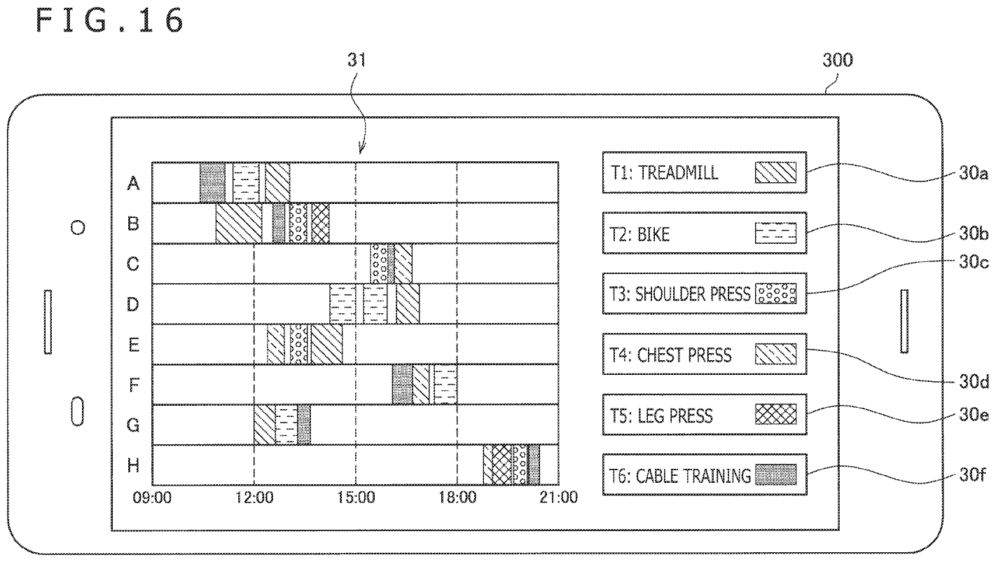

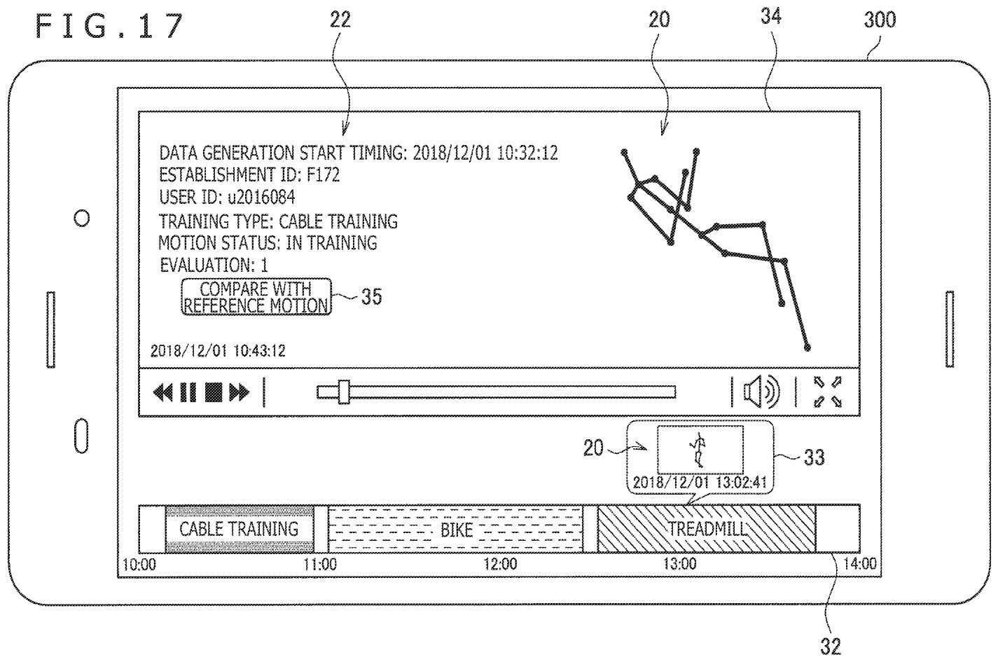

Further, the output control section 118 may cause the own apparatus or the output apparatus 300 (external apparatus) to display the results of motion evaluations output in the past. Explained below with reference to FIGS. 16 and 17 are display examples of the results of motion evaluations output in the past.

FIG. 16 depicts a specific example of the screen displayed to verify the results of evaluating the motions of multiple users over a given time period. The right side of the screen in FIG. 16 depicts a list of training types 30 (training types 30a through 30f in the example of FIG. 16). The left side of the screen illustrates a time chart 31 indicating the details of training performed by multiple users over a given time period (in the example of FIG. 16, the details of training performed by users A through H from 9:00 through 21:00). In the time chart in the example of FIG. 16, a time slot in which each user did training is given a texture corresponding to the training type 30 in question, which indicates the details of training performed by the users. A user in person or some other person (e.g., trainer in the gym) acting as an operator performs predetermined input such as a touch on the screen in FIG. 16 to select the desired user. This causes a transition to the screen of FIG. 17, for example.

FIG. 17 depicts a specific example of the screen displayed to verify the results of evaluating the motion previously performed by a user over a given time period. Depicted in FIG. 17 is a typical screen displayed when the user A is selected on the screen of FIG. 16. The underside of the screen in FIG. 17 displays a time chart 32 indicating the details of training performed by a given user (in the example of FIG. 17, the details of training performed by user A from 10:00 through 14:00). The operator selects a time of day at which the training type is indicated on the time chart 32, using a predetermined method (e.g., a tap). The selection causes a window 33 to appear that displays the posture information (first image data 20) at that time of day. By viewing the window 33, the operator can search for the time of day at which the desired training is performed.

When the selection in the time chart 32 is finalized by a predetermined method (e.g., double tap), a window 34 on the upper side of the screen in FIG. 17 displays the posture information (first image data 20) at that time of day together with tag data 22. The display allows the operator to easily verify the details of the desired training. The window 34 also displays a “Compare with Reference Motion” button 35. When the operator selects the “Compare with Reference Motion” button 35 by a predetermined method (e.g., tap), the window 34 displays the first image data 20 indicative of the motion of the user and the second image data 21 indicative of the reference motion, as depicted in FIGS. 12 through 15. The display allows the operator to better recognize both the user's motion and the reference motion and make easy comparisons therebetween. It is to be noted that the information that the output control section 118 causes the output apparatus 300 to display is not limited to the examples in FIGS. 12 through 17.

### 5. MODIFICATION EXAMPLE

The preceding paragraphs explain the variations of the information that the output control section 118 causes the output apparatus 300 or the like to display. What follows is a description of a modification example of the present embodiment.

In the information processing apparatus 100 according to the above-described present embodiment, tag data is added to units of the data regarding each user (e.g., units of the image data extracted by the data extraction section 111), the data being extracted from the data recorded of the motions of multiple users (e.g., image data output from the imaging apparatus 210). On the basis of the added tag data, the motion of each user is evaluated. The information processing apparatus 100 according to a modification example, on the other hand, evaluates the collective motions of multiple users in a case where these users perform their motions collectively. More specifically, in the case where multiple users perform their motions collectively, the information processing apparatus 100 of the modification example adds tag data to units of the data regarding these users. On the basis of the tag data thus added, the collective motions of the multiple users are evaluated.

In this manner, in a case where multiple users collectively play “volley ball,” for example, the above-described embodiment may regard individual users' motions such as “serve,” “receive,” “toss,” and “spike” as the evaluation targets. The modification example, by contrast, may regard as the evaluation target the collective motions of “volley ball” performed by the multiple users. Obviously, “volley ball” is only an example. Other motions will also apply as long as they are done collectively by multiple users (e.g., “dance,” “cooking,” “conference,” or “line up”).

Given that the occurrence of abnormalities may not be detected appropriately by simply evaluating the motion of each user, the information processing apparatus 100 of the modification example may evaluate not only the motion of each user but also the collective motions of the users in order to better detect the occurrence of any anomaly. For example, there may be cases in which, while multiple users have been performing their motions collectively, an anomaly causes all the users to look in the same direction collectively, to stop their motions collectively, or to run away collectively (i.e., to flee). In such cases, simply evaluating the motion of each user may not be sufficient for appropriately detecting the occurrence of the anomaly. By contrast, the information processing apparatus 100 of the modification example also evaluates the collective motions of the multiple users so as to better detect the occurrence of abnormalities.

The configuration of the information processing apparatus 100 according to the modification example is explained hereunder. The motion estimation section 116 of the information processing apparatus 100 not only estimates the motion of each user using the method explained above in conjunction with the embodiment but also determines whether or not the collective motions of the users are related to each other. For example, in the case where the motions of individual users are “serve,” “receive,” “toss,” and “spike,” the motion estimation section 116 determines that these motions are related to each other in that they constitute “volley ball.” The motion estimation section 116 then supplies information regarding the estimated motions to the tag addition section 115. In turn, the tag addition section 115 adds tag data (e.g., the tag data of “volley ball”) regarding the estimated motions to the image data representing visually the motions of the multiple users. Here, the “image data representing visually the motions of the multiple users” may be the image data output unmodified from the imaging apparatus 210 or the image data extracted from the output image data by the data extraction section 111. On the basis of the tag data, the motion evaluation section 117 evaluates the collective motions of the multiple users. In this case, the reference motion DB 123 stores the feature quantities of the reference motions with respect to the motions performed collectively by multiple users (e.g., “volley ball”) and the stored feature quantities are used for motion evaluation. When the motion evaluation section 117 supplies the tag addition section 115 with the information regarding the evaluated motions, the tag addition section 115 adds the tag data regarding the motion evaluation not only to the image data representing visually the motion of each user but also to the image data representing visually the collective motions of the users. The other aspects of the configuration of the information processing apparatus 100 are similar to those discussed above with reference to FIGS. 1 and 2.

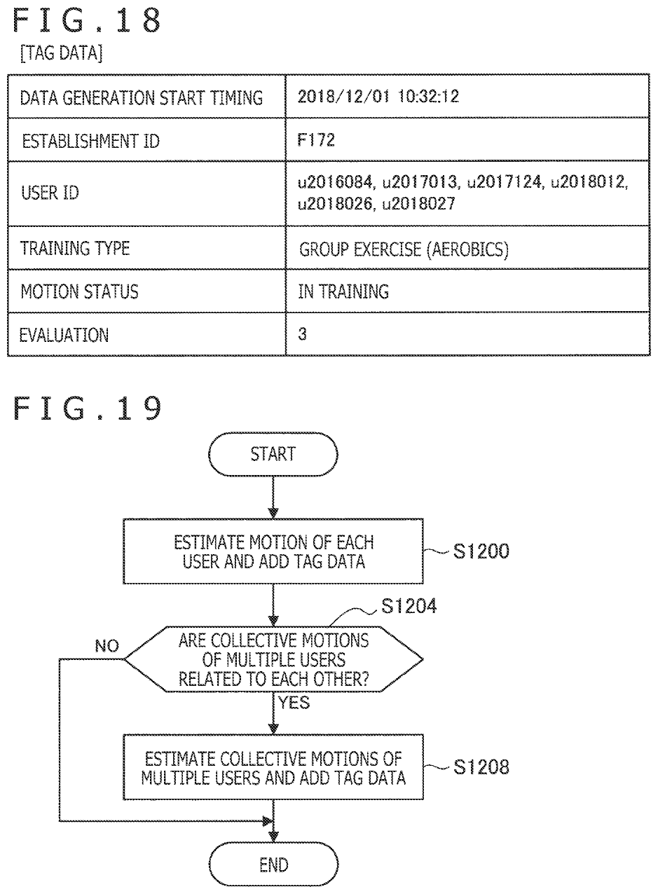

FIG. 18 is a diagram depicting a specific example of tag data according to the modification example. Compared with FIG. 6 explained above in conjunction with the embodiment, the tag data item “user ID” in FIG. 18 represents multiple user IDs, and the item “training type” indicates “group exercise (aerobics)” as the collective motions of the multiple users. As with FIG. 6, the example in FIG. 18 is not limitative of the types and specifics of the tag data.

Explained below is a process flow of the information process system according to the modification example. FIG. 19 is a flowchart depicting more specifically the process of step S1028 in FIG. 10 (estimation of motions and addition of tag data) according to the modification example. In step S1200, the motion estimation section 116 estimates the motion of each user, and the tag addition section 115 adds tag data regarding the estimated motion to the image data. In step S1204, the motion estimation section 116 determines whether or not the collective motions of the individual users are related to each other. In a case where the collective motions of the individual users are related to each other (step S1204/Yes), step S1208 is reached. In step S1208, the motion estimation section 116 estimates the collective motions of the multiple users, and the tag addition section 115 adds tag data regarding the estimated motions to the image data. In a case where collective motions of the individual users are not related to each other (step S1204/No), the process of step S1208 is omitted.

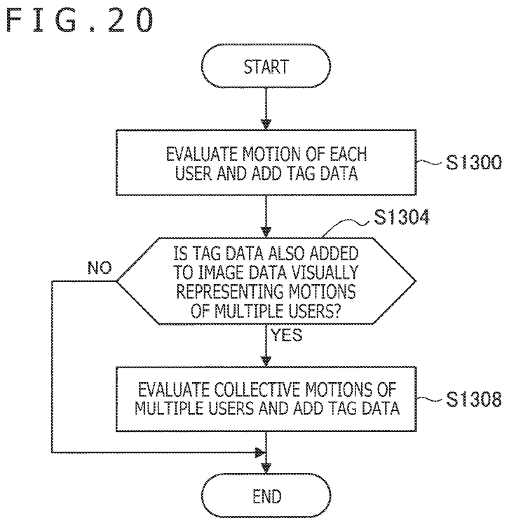

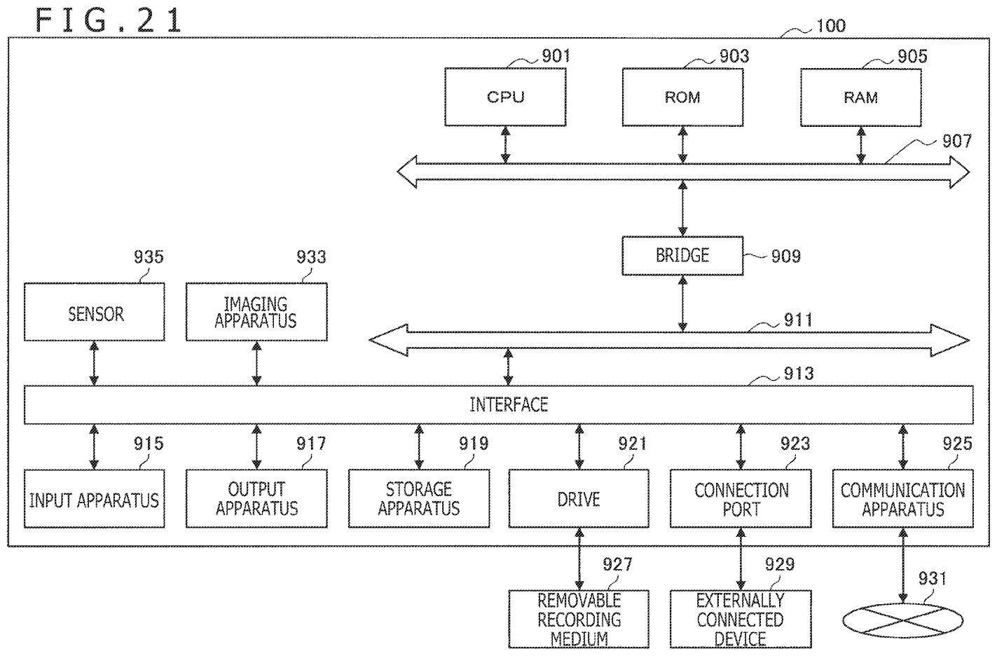

FIG. 20 is a flowchart depicting more specifically the process of step S1036 in FIG. 10 (evaluation of motions and addition of tag data) according to the modification example. In step S1300, the motion evaluation section 117 evaluates the motion of each user, and the tag addition section 115 adds tag data regarding the evaluated motion to image data. In step S1304, the motion evaluation section 117 determines whether or not tag data is added to the image data representing visually the motions of multiple users. In a case where the tag data is added to the image data representing visually the motions of the multiple users (step S1304/Yes), step S1308 is reached. In step S1308, the motion evaluation section 117 evaluates the collective motions of the multiple users, and the tag addition section 115 adds tag data regarding the evaluated motions to the image data. In a case where the tag data is not added to the image data representing visually the motions of the multiple users (step S1304/No), step S1308 is omitted.

### 6. HARDWARE CONFIGURATION EXAMPLE

Explained next with reference to FIG. 21 is a hardware configuration of the information processing apparatus 100 according to the present embodiment or the modification example. FIG. 21 is a block diagram depicting a hardware configuration example of the information processing apparatus 100 of the present embodiment or the modification example.

The information processing apparatus 100 includes a CPU (Central Processing unit) 901, a ROM (Read Only Memory) 903, and a RAM (Random Access Memory) 905. The information processing apparatus 100 may also include a host bus 907, a bridge 909, an external bus 911, an interface 913, an input apparatus 915, an output apparatus 917, a storage apparatus 919, a drive 921, a connection port 923, and a communication apparatus 925. The information processing apparatus 100 may further include an imaging apparatus 933 and sensors 935 as needed. The information processing apparatus 100 may have processing circuits such as a DSP (Digital Signal Processor), ASIC (Application Specific Integrated Circuit), or FPGA (Field-Programmable Gate Array) in place of, or in addition to, the CPU 901.

The CPU 901 functions as an arithmetic processing unit and control apparatus, controlling part or all of the internal operations of the information processing apparatus 100 in accordance with various programs recorded in the ROM 903, the RAM 905, the storage apparatus 919, or on a removable recording medium 927. The ROM 903 stores the programs and operation parameters for use by the CPU 901. The RAM 905 temporarily stores the programs used by the CPU 901 for process execution and the parameters that may vary as needed during the execution. The CPU 901, the ROM 903, and the RAM 905 are interconnected via the host bus 907 constituted by internal buses including a CPU bus. The host bus 907 is further connected with the external bus 911 such as a PCI (Peripheral Component Interconnect/Interface) bus via the bridge 909. The CPU 901, the ROM 903, and the RAM 905 operate in coordination with each other to implement the functions of the control section 110 in the information processing apparatus 100.

The input apparatus 915 is an apparatus operated by the user using, for example, a mouse, a keyboard, a touch panel, buttons, switches, and levers. For example, the input apparatus 915 may be a remote-control apparatus using infrared rays or other radio waves, or an externally connected device 929 such as a mobile phone corresponding to the operations of the information processing apparatus 100. The input apparatus 915 includes an input control circuit that generates input signals based on the information input by the user and outputs the generated signals to the CPU 901. By operating the input apparatus 915, the user inputs diverse data and gives processing operation instructions to the information processing apparatus 100.

The output apparatus 917 is configured with an apparatus capable of notifying the user of acquired information using such senses as vision, hearing, and touch. For example, the output apparatus 917 may be a display apparatus such as an LCD (Liquid Crystal Display) or an organic EL (Electro-Luminescence) display, an audio output apparatus such as speakers or headphones, or a vibrator. The output apparatus 917 outputs the results of the processing by the information processing apparatus 100 in the form of visual representation such as texts or images, audio information such as voices or sounds, or vibration.

The storage apparatus 919 is configured to be a data storage apparatus as an example of the storage section 120 of the information processing apparatus 100. For example, the storage apparatus 919 is configured using a magnetic storage device such as HDD (Hard Disk Drive), a semiconductor storage device, an optical storage device, or a magneto-optical storage device. The storage apparatus 919 stores, for example, the programs and data to be used and operated on by the CPU 901, as well as diverse data acquired from the outside.

The drive 921 is a reader/writer for use with the removable recording medium 927 such as a magnetic disk, an optical disk, a magneto-optical disk, or a semiconductor memory. The drive 921 is incorporated in, or externally attached to, the information processing apparatus 100. The drive 921 reads information from a piece of the removable recording medium 927 loaded therein, and outputs the retrieved information to the RAM 905. Also, the drive 921 writes information to the loaded piece of the removable recording medium 927.

The connection port 923 is used to connect a device with the information processing apparatus 100. For example, the connection port 923 may be a USB (Universal Serial Bus) port, an IEEE 1394 port, or an SCSI (Small Computer System Interface) port. Alternatively, the connection port 923 may be an RS-232C port, an optical audio terminal, or an HDMI (registered trademark) (High-Definition Multimedia Interface) port. Connecting the externally connected device 929 to the connection port 923 makes it possible to exchange diverse data between the information processing apparatus 100 and the externally connected device 929.

The communication apparatus 925 is a communication interface configured, for example, with a communication device for connecting with a communication network 931. The communication apparatus 925 may be a communication card for LAN (Local Area Network), Bluetooth (registered trademark), Wi-Fi, or WUSB (Wireless USB) use, for example. Alternatively, the communication apparatus 925 may be an optical communication router, an ADSL (Asymmetric Digital Subscriber Line) router, or any one of diverse communication modems. The communication apparatus 925 sends and receives signals to and from the Internet or other communication devices, for example, using a predetermined protocol such as TCP/IP. Further, the communication network 931 is a network connected with the communication apparatus 925 in wired or wireless fashion. The communication network 931 may include the Internet, a household LAN, infrared communication, radio wave communication, or satellite communication, for example. The communication apparatus 925 implements the functions of the communication section 130 in the information processing apparatus 100.

The imaging apparatus 933 is an apparatus that generates captured images by imaging the real space using various components including an image sensor with CMOS (Complementary Metal Oxide Semiconductor) or CCD (Charge Coupled Device), and lenses for controlling the formation of subject images on the image sensor. The imaging apparatus 933 may capture still images or moving images.

The sensors 935 may be diverse sensors such as an acceleration sensor, an angular velocity sensor, a geomagnetic sensor, an illumination sensor, a temperature sensor, an atmospheric pressure sensor, or a sound sensor (microphone). The sensors 935 acquire information regarding the status of the information processing apparatus 100 itself such as the posture of its housing, and information regarding the surrounding environment of the information processing apparatus 100 such as brightness and noise in the surroundings. The sensors 935 may further include a GPS receiver receiving GPS (Global Positioning System) signals to measure the longitude, latitude, and altitude of the information processing apparatus 100.

The preceding paragraphs describe the hardware configuration example of the information processing apparatus 100. The constituent elements described above may be configured using general-purpose components or may be constituted with hardware specializing in the functions of the constituent elements. The configuration may be varied as needed depending on the technical level at the time of implementation.

### 7. CONCLUSION

As explained above, the information processing apparatus 100 according to the present embodiment estimates given motions by analyzing the data recorded of the motions of multiple users, adds tag data regarding the estimated motions, and evaluates the estimated motions by comparing them with the reference motions on the basis of the tag data. In this manner, the information processing apparatus 100 evaluates the motions of multiple users more efficiently. For example, in a case where images are captured of multiple users doing various motions, the information processing apparatus 100 analyzes the captured image data representing visually the motions of the multiple users so as to evaluate the motion of each user more efficiently.

Further, adding the tag data enables the information processing apparatus 100 to analyze image data over an extended time period (e.g., for several hours to several days). For example, in a case where the image data acquired for a long time in the past is to be analyzed collectively to evaluate motions, the information processing apparatus 100 can smoothly recognize the reference motions to be compared with the motions of users on the basis of the tag data added to the image data. This enables the information processing apparatus 100 to compare the users' motions with the reference motions more efficiently. Further, with the tag data designated, the information processing apparatus 100 can easily search for and acquire the data targeted for output out of large amounts of data.

Furthermore, in a case where multiple users are doing motions collectively, the information processing apparatus 100 of the modification example adds tag data to units of the data regarding the multiple users. On the basis of the tag data thus added, the information processing apparatus 100 can more appropriately evaluate the collective motions of the multiple users.

Whereas some preferred embodiments of the present disclosure have been described above in detail with reference to the accompanying drawings, these embodiments are not limitative of the technical scope of this disclosure. It is obvious that those skilled in the art will easily conceive variations or alternatives of the disclosure within the scope of the technical idea stated in the appended claims. It is to be understood that such variations, alternatives, and other ramifications also fall within the technical scope of the present disclosure.

Further, the advantageous effects stated in this description are only for illustrative purposes and are not limitative of the present disclosure. That is, in addition to or in place of the above-described advantageous effects, the technology of the present disclosure may provide other advantageous effects that will be obvious to those skilled in the art in view of the above description.

Incidentally, the following configurations also fall within the technical scope of the present disclosure.

(1)

An information processing apparatus including:

a motion estimation section configured to analyze data recorded of motions of multiple users so as to estimate the motions;

a tag addition section configured to add tag data regarding the motions to at least part of the recorded data; and

a motion evaluation section configured to evaluate the motions by comparing the motions with reference motions on the basis of the tag data.

(2)

The information processing apparatus according to (1), in which the motion evaluation section compares the motions with the reference motions so as to output a value permitting evaluation of whether or not there is an anomaly in the motions.

(3)

The information processing apparatus according to (2), in which the reference motions include a normal, ideal, or abnormal motion, or a motion performed by a user in the past, with respect to the motions estimated by the motion estimation section.

(4)

The information processing apparatus according to any one of (1) to (3), in which the tag addition section adds the tag data either to units of the data regarding each user out of the recorded data or to units of the data regarding a plurality of users out of the recorded data.

(5)

The information processing apparatus according to (4), in which, in addition to the tag data regarding the motions, the tag data includes tag data regarding the users and tag data regarding the recorded data.

(6)

The information processing apparatus according to any one of (1) to (5), further including:

an output control section configured to control own apparatus or an external apparatus to output a result of evaluating the motions.

(7)

The information processing apparatus according to (6), in which the output control section causes the own apparatus or the external apparatus to display first image data indicative of the motions and second image data indicative of the reference motions.

(8)

The information processing apparatus according to (7), in which the output control section causes the own apparatus or the external apparatus to display the first image data and the second image data being overlaid on one another.

(9)

The information processing apparatus according to (7) or (8), in which the output control section causes the own apparatus or the external apparatus to display the first image data together with two or more items of the second image data.

(10)

The information processing apparatus according to any one of (6) to (9), in which, on the basis of the tag data designated from outside, the output control section acquires the data to which the tag data is added, and controls the own apparatus or the external apparatus to output the acquired data.

(11)

The information processing apparatus according to any one of (1) to (10), in which the recorded data includes image data output from an imaging apparatus.

(12)

The information processing apparatus according to any one of (1) to (11), in which the motions include a form related to training or to sports.

(13)

An information processing method to be executed by a computer, the information processing method including:

analyzing data recorded of motions of multiple users so as to estimate the motions;

adding tag data regarding the motions to at least part of the recorded data; and

evaluating the motions by comparing the motions with reference motions on the basis of the tag data.

### REFERENCE SIGNS LIST

100: Information processing apparatus
110: Control section
111: Data extraction section
112: Posture estimation section
113: Reconstitution section
114: User identification section
115: Tag addition section
116: Motion estimation section
117: Motion evaluation section
118: Output control section
120: Storage section
121: User DB
122: Motion DB
123: Reference motion DB
124: Evaluation result DB
130: Communication section
200: Sensor group
210: Imaging apparatus
211: IMU
300: Output apparatus
400: Network

1. An information processing apparatus comprising:
a motion estimation section configured to analyze data recorded of motions of a plurality of users so as to estimate the motions;
a tag addition section configured to add tag data regarding the motions to at least part of the recorded data; and
a motion evaluation section configured to evaluate the motions by comparing the motions with reference motions on a basis of the tag data.

2. The information processing apparatus according to claim 1, wherein the motion evaluation section compares the motions with the reference motions so as to output a value permitting evaluation of whether or not there is an anomaly in the motions.

3. The information processing apparatus according to claim 2, wherein the reference motions include a normal, ideal, or abnormal motion, or a motion performed by a user in the past, with respect to the motions estimated by the motion estimation section.

4. The information processing apparatus according to claim 1, wherein the tag addition section adds the tag data either to units of the data regarding each user out of the recorded data or to units of the data regarding a plurality of users out of the recorded data.

5. The information processing apparatus according to claim 4, wherein, in addition to the tag data regarding the motions, the tag data includes tag data regarding the users and tag data regarding the recorded data.

6. The information processing apparatus according to claim 1, further comprising:
an output control section configured to control own apparatus or an external apparatus to output a result of evaluating the motions.

7. The information processing apparatus according to claim 6, wherein the output control section causes the own apparatus or the external apparatus to display first image data indicative of the motions and second image data indicative of the reference motions.

8. The information processing apparatus according to claim 7, wherein the output control section causes the own apparatus or the external apparatus to display the first image data and the second image data being overlaid on one another.

9. The information processing apparatus according to claim 7, wherein the output control section causes the own apparatus or the external apparatus to display the first image data together with two or more items of the second image data.

10. The information processing apparatus according to claim 6, wherein, on a basis of the tag data designated from outside, the output control section acquires the data to which the tag data is added, and controls the own apparatus or the external apparatus to output the acquired data.

11. The information processing apparatus according to claim 1, wherein the recorded data includes image data output from an imaging apparatus.

12. The information processing apparatus according to claim 1, wherein the motions include a form related to training or to sports.

13. An information processing method to be executed by a computer, the information processing method comprising:
analyzing data recorded of motions of a plurality of users so as to estimate the motions;
adding tag data regarding the motions to at least part of the recorded data; and
evaluating the motions by comparing the motions with reference motions on a basis of the tag data.
